(19) United States
(12) Patent Application Publication
(10) Pub. No.: US 2006/0161547 A1
(43) Pub. Date: Jul. 20, 2006

(54) Communication apparatus, communication method, and recording medium

(76) Inventor: Yohko Ohtani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/319,066

(22) Filed: Dec. 28, 2005

(30) Foreign Application Priority Data
Jan. 7, 2005 (JP) 2005-002652

(51) Int. Cl. G06F 17/30

(52) U.S. Cl. 707/9

(57) ABSTRACT

There is disclosed a communication apparatus that operates as a client of a first server having a referral function for referring the communication apparatus to a second server that performs an operation requested by the communication apparatus. The communication apparatus comprises a requesting unit that sends, to the first server or the second server that manages information about a user of the communication apparatus, a request for the operation for applying a use restriction of one or more functions of the communication apparatus, a setting unit that determines whether to enable or disable a referral using the referral function, and a use restricting unit that applies the use restriction of one or more functions of the communication apparatus according to a response to the request sent from the requesting unit and the determination by the setting unit.

### BACKGROUND OF THE INVENTION

1. Field of the Invention

The present invention relates to a communication device such as an image forming apparatus including a copier, a printer, a scanner, a facsimile, a complex device, and a multifunction device, and an information processing apparatus including a personal computer; a communication method; and a recording medium.

2. Description of the Related Art

In recent year, complex devices and multifunction devices having copy, printer, scanner, and facsimile functions have been available in the market. The complex devices can print images on paper when used as copiers or printers, scan images from originals when used as copiers or scanners, and send and receive images to and from other communication apparatuses through telephone lines when used as facsimiles.

<Patent Document 1> Japanese Patent Laid-Open Publication No. 2002-084383

<Patent Document 2> Japanese Patent Laid-Open Publication No. 2004-122778

Some of the functions of the complex devices and multifunction devices use “user information”. For example, when the complex devices and the multifunction devices are used as scanners or facsimiles, “user information” such as mail address and facsimile telephone numbers is used. Although the complex devices and the multifunction devices generally have management functions for managing such user information, it would be useful for the complex devices and the multifunction devices to have acquisition functions for acquiring such user information from “servers”. LDAP (Lightweight Directory Access Protocol) servers are a typical example of such “servers”.

In LDAP, persons and organizations are recognized as “objects”. Information about an individual object is stored in an entry for information management. The entry contains an “object class”, which is information about the type of the object, and an “attribute” which is information about object characteristics. The attribute consists of “attribute types” such as c (country), o (organization), ou (organization unit), cn (common name), sn (last name), givenName (first name), uid (user ID), userPassword (user password), mail (mail address), and facsimileTelephoneNumber (facsimile telephone number), and “attribute values” such as c:Japan/o:Ricoh/ou:R&D division/cn:Taro Suzuki/sn:Suzuki/givenName:Taro. Each entry has a hierarchical structure according to its object class. A distinguished name (DN) of the entry is formed from hierarchically ordered relative distinguished names (RDNs) from its attributes (identification attributes).

Various requests and responses are exchanged between LDAP servers and LDAP clients. LDAP supports authentication related operations (e.g. bind, unbind), query related operations (e.g. search, compare), update related operations (add, delete, modify), referrals (a function where an LDAP server refers an LDAP client to another LDAP server), and chaining (a function where an LDAP server contacts another LDAP server). For example, if an LDAP client sends a search request for a search operation to an LDAP server, the LDAP server sends a response (search result) to the LDAP client using referrals and chaining as necessary.

As information processing functions of complex devices and multifunction devices have become more sophisticated, more and more complex devices and multifunction devices are configured to support user authentication. Examples of the user authentication supported by the complex devices and the multifunction devices include “local authentication” performed by the complex devices and the multifunction devices, and “remote authentication” performed by authentication servers (e.g. LDAP authentication and NT authentication performed by LDAP servers and NT servers).

Also, as information processing functions of complex devices and multifunction devices have become more sophisticated, more and more complex devices and multifunction devices are configured to support use restriction operations. It would be convenient if use restrictions of the functions of the complex devices and the multifunction devices could be enforced a per-user group basis (e.g. permission to use the devices is granted to users belonging to a company but not granted to users not belonging to the company). For instance, in the case of complex devices and multifunction devices that use LDAP authentication, users may be divided into groups based on their LDAP attributes such that use restrictions may be set in the devices on a per-user group basis. If so, although the user groups can be customized in detail, it is difficult for an operator unfamiliar with LDAP attribute to divide the users into groups. Therefore, there has been a demand for a method of easily grouping users and setting use restrictions on a per-user group basis.

### SUMMARY OF THE INVENTION

The present invention may solve at least one problem described above.

According to an aspect of the present invention, there is provided a method of easily grouping users and enforcing use restrictions on a per-user group basis so as to restrict use of functions of a “communication apparatus” such as an image forming apparatus and an information processing apparatus.

According to another aspect of the present invention, there is provided a communication apparatus operating as a client of a first server having a referral function for referring the communication apparatus to a second server that performs an operation requested by the communication apparatus, the communication apparatus comprising a requesting unit that sends, to the first server or the second server that manages information about a user of the communication apparatus, a request for the operation for applying a use restriction of one or more functions of the communication apparatus, a setting unit that determines whether to enable or disable a referral using the referral function, and a use restricting unit that applies the use restriction of one or more functions of the communication apparatus according to a response to the request sent from the requesting unit and the determination by the setting unit.

According to still another aspect of the present invention, there is provided a communication method performed by a communication apparatus operating as a client of a first server, the first serer having a referral function for referring the communication apparatus to a second server that performs an operation requested by the communication apparatus, the method comprising a requesting step of sending, to the first server or the second server that manages information about a user of the communication apparatus, a request for the operation for applying a use restriction of one or more functions of the communication apparatus, a setting step of determining whether to enable or disable a referral using the referral function, and a use restricting step of applying the use restriction of one or more functions of the communication apparatus according to a response to the request sent in the requesting step and the determination in the setting step.

According to a further aspect of the present invention, there is provided a recording medium storing a program executable by a communication apparatus operating as a client of a first server having a referral function for referring the communication apparatus to a second server that performs an operation requested by the communication apparatus, the program comprising a requesting instruction for sending, to the first server or the second server that manages information about a user of the communication apparatus, a request for the operation for applying a use restriction of one or more functions of the communication apparatus, a setting instruction for determining whether to enable or disable a referral using the referral function, and a use restricting instruction for applying the use restriction of one or more functions of the communication apparatus according to a response to the request sent according to the requesting instruction and the determination according to the setting instruction.

According to another further aspect of the present invention, there is provided a communication method for use in a first server having a referral function for referring a communication apparatus to a second server that performs an operation requested by the communication apparatus, and in the communication apparatus operating as a client of the first server, the method comprising a requesting step of causing the communication apparatus to send, to the first server or the second server that manages information about a user of the communication apparatus, a request for the operation for applying a use restriction of one or more functions of the communication apparatus, a setting step of causing the communication apparatus to determine whether to enable or disable a referral using the referral function, and a use restricting step of causing the communication apparatus to apply the use restriction of one or more functions of the communication apparatus according to a response to the request sent in the requesting step and the determination in the setting step.

### BRIEF DESCRIPTION OF THE DRAWINGS

FIG. 1 is a block diagram illustrating a software configuration of a multifunction device according to an embodiment of the present invention;

FIG. 2 is a block diagram illustrating a hardware configuration of a multifunction device according to an embodiment of the present invention;

FIG. 3 is a schematic diagram illustrating a network including a multifunction device according to an embodiment of the present invention;

FIG. 4 is a conceptual diagram illustrating information management by LDAP servers and NT servers;

FIGS. 5A-5C are tables showing examples of use restriction setting and referral setting;

FIGS. 6A-6C are screens used for use restriction setting and referral setting;

FIG. 7 is a sequence diagram illustrating a first example of the process flow of authentication (LDAP authentication);

FIG. 8 is a sequence diagram illustrating a second example of the process flow of authentication (LDAP authentication);

FIG. 9 is a sequence diagram illustrating a third example of the process flow of authentication (NT authentication);

FIG. 10 is a sequence diagram illustrating a fourth example of the process flow of authentication (NT authentication);

FIG. 11 is a flowchart illustrating a use restriction operation;

FIG. 12 is a sequence diagram illustrating steps taken when an authentication operation and a use restriction operation are separately performed;

FIG. 13 is a sequence diagram illustrating steps taken when an authentication operation and a use restriction operation are jointly performed;

FIGS. 14A-14C show examples of an authentication screen, a copier application screen, and a scanner application screen;

FIG. 15 is a sequence diagram illustrating a modified example of FIGS. 12 and 13;

FIG. 16 is a flowchart showing a color copying charging operation;

FIG. 17 is a flowchart showing a monochrome copying charging operation; and

FIGS. 18A-18C show examples of an authentication screen, a request screen, and a restriction screen.

### DETAILED DESCRIPTION OF THE PREFERRED EMBODIMENT

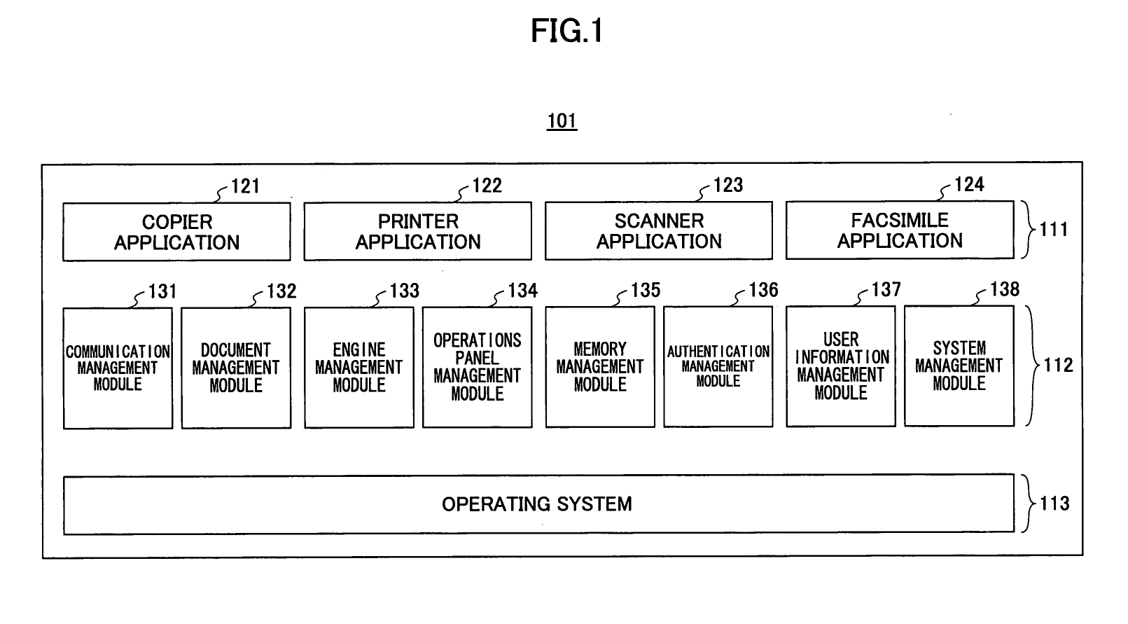

FIG. 1 is a block diagram illustrating a software configuration of a multifunction device 101 according to an embodiment of the present invention. The multifunction device 101 comprises various applications 111, various platforms 112, and an operating system 113.

The applications 111 include a copier application 121 having a copy function, a printer application 122 having a printer function, a scanner application 123 having a scanner function, and a facsimile application 124 having a facsimile function.

The platforms 112 include a communication management module 131 for communication management, a document management module 132 for document management, an engine management module 133 for engine management, an operations panel management module 134 for operations panel management, a memory management module 135 for memory management, an authentication management module 136 for authentication management, a user information management module 137 for user information management, and a system management module 138 for system management.

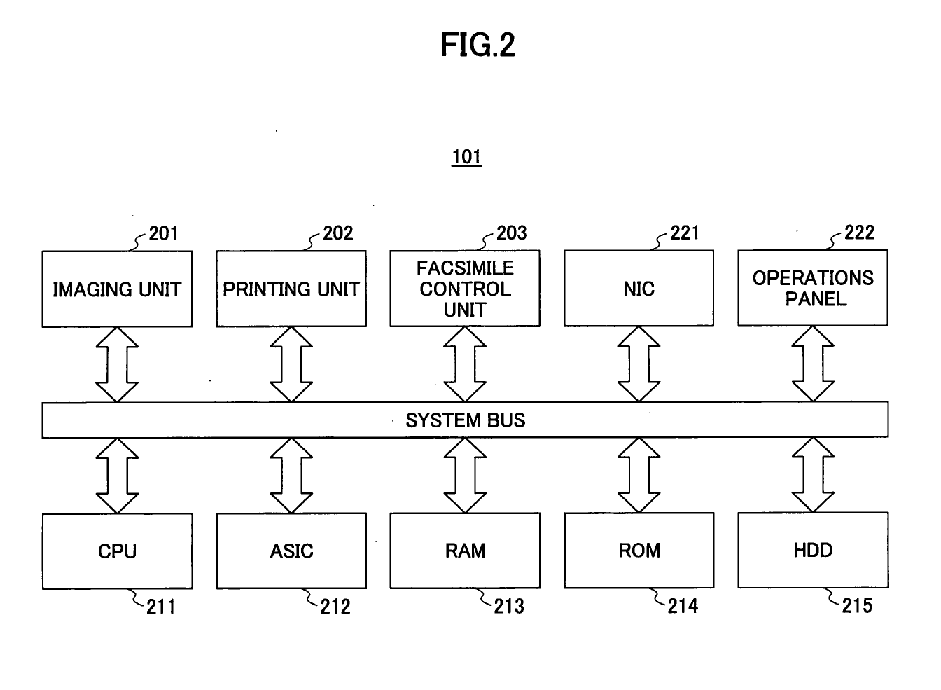

FIG. 2 is a block diagram illustrating a hardware configuration of the multifunction device 101 according to an embodiment of the present invention. The multifunction device 101 further comprises an imaging unit 201, a printing unit 202, a facsimile control unit 203, a CPU 211, an ASIC 212, a RAM 213, a ROM 214, a HDD 215, a NIC 221, and an operations panel 222.

The imaging unit 201 scans images from originals. The printing unit 202 prints images on paper. The facsimile control unit 203 controls the facsimile functions. The CPU 211 is an integrated circuit that processes various information items. The ASIC 212 is an integrated circuit that processes various images. The RAM 213 is a memory (volatile memory) within the multifunction device 101. The ROM 214 is a memory (nonvolatile memory). The HDD 215 is storage within the multifunction device 101. The NIC 221 is a communication unit as a network interface of the multifunction device 101. The operations panel 222 is an operations display unit as a user interface of the multifunction device 101.

The applications 111, the platforms 112, and the operating system 113 of FIG. 1 are stored in the ROM 214 and the HDD 215 of FIG. 2.

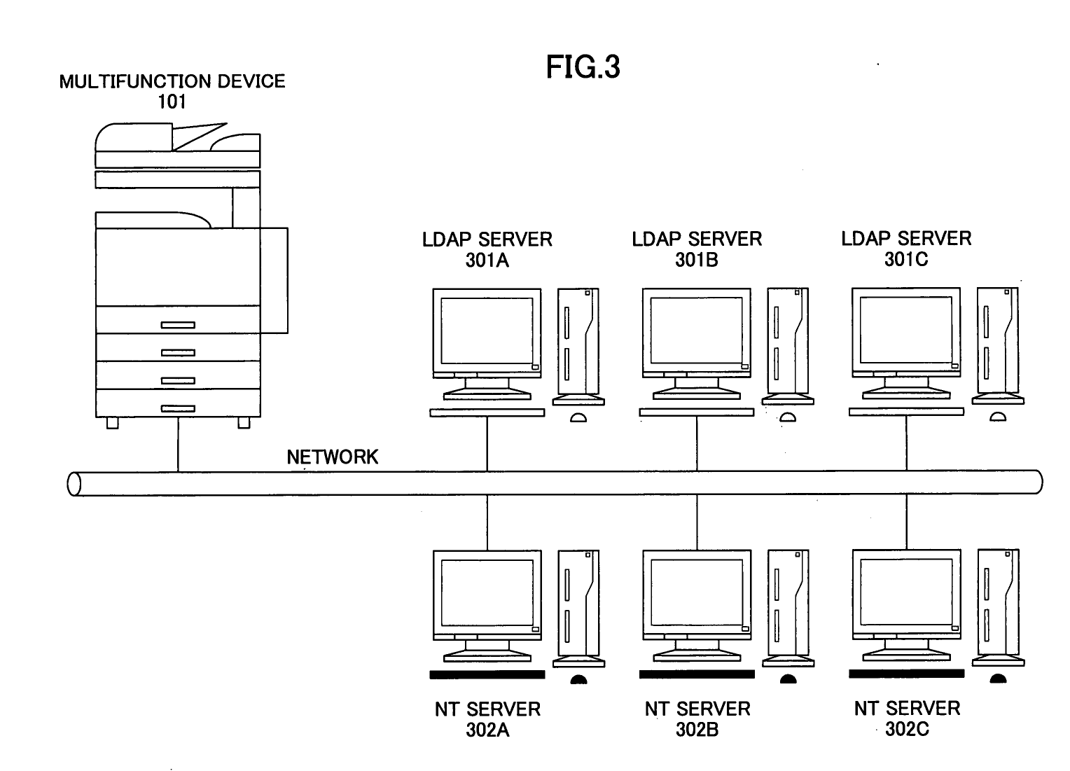

FIG. 3 is a schematic diagram illustrating a network including the multifunction device 101 according to an embodiment of the present invention. The multifunction device 101 is connected to an LDAP server 301A, an LDAP server 301B, an LDAP server 301C, an NT server 302A, an NT server 302B, and an NT server 302C over the network.

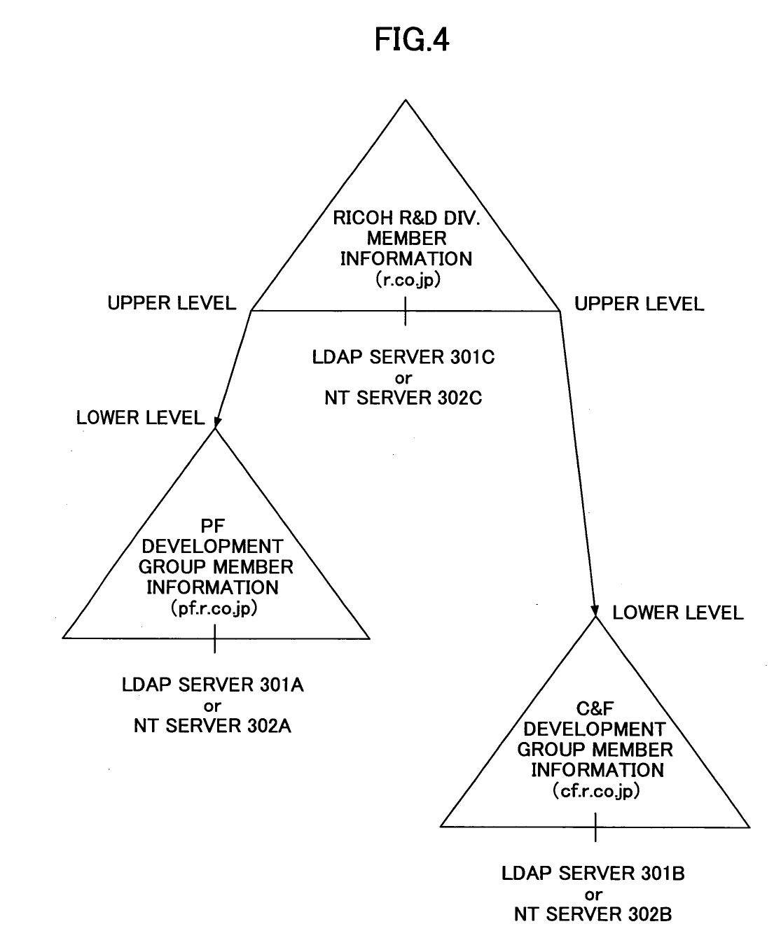

The LDAP servers 301 and the NT servers 302 store information about, for example, members of an R&D division as shown in FIG. 4. The LDAP server 301A and the NT server 302A manage information about, for example, members of a PF development group of the R&D division. The LDAP server 301B and the NT server 302B manage information about, for example, members of a C&F development group of the R&D division. The LDAP server 301C and the NT server 302C consolidate the information about the members of the R&D division.

In this embodiment, the NT server 302A corresponds to a domain controller (DC) for a domain for the PF development group of the R&D division. The NT server 302B corresponds to a domain controller (DC) for a domain for the C&F development group of the R&D division. The NT server 302C corresponds to a domain controller (DC) for a domain for the R&D division. The NT servers 302A, 302B, and 302C include Active Directory (AD). Accordingly, the LDAP servers 301A, 301B, and 301C and the NT servers 302A, 302B, and 302C support “LDAP” as a communication protocol.

Moreover, both the LDAP servers 301 and the NT servers 302 support LDAP referrals. For example, when the multifunction device 101 sends a request for an operation to the LDAP server 301A or the NT server 302A, the LDAP server 301A or the NT server 302A refers the multifunction device 101 to another server (the LDAP server 301B or 301C, or the NT server 302B or 302C) depending on the result of the operation.

In the multifunction device 101, use restrictions of the functions of the multifunction device 101 can be imposed (use restriction setting). Further, in the multifunction device 101, LDAP referrals for authentication operations for performing operations of restricting the use of the functions of the multifunction device 101 can be enabled or disabled (referral setting).

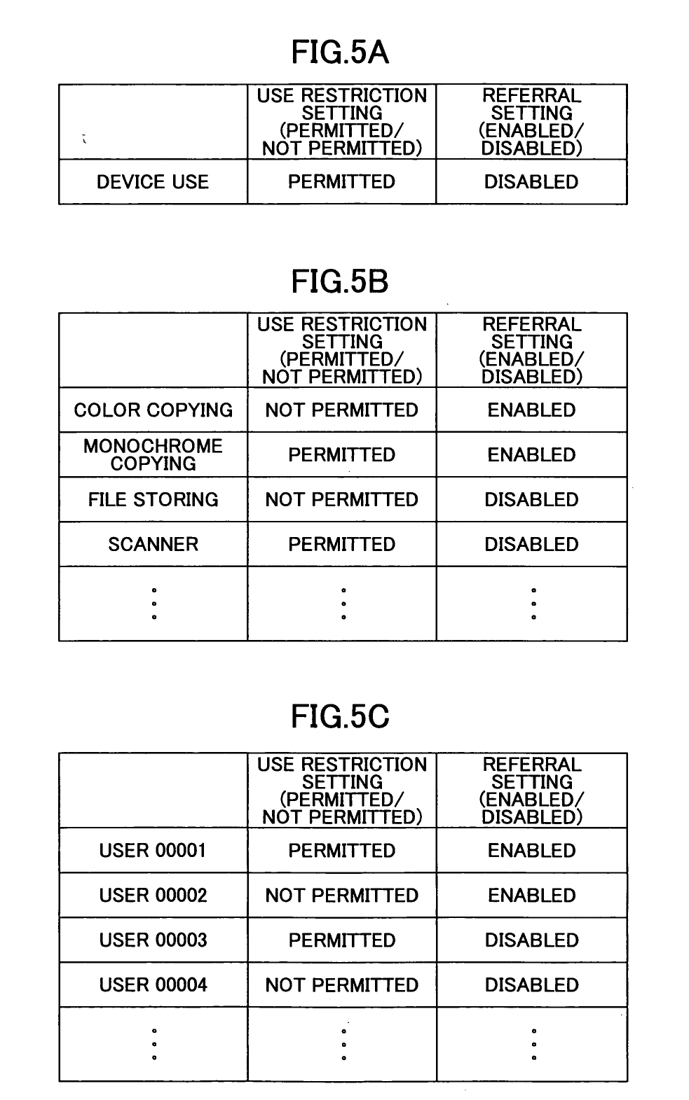

FIGS. 5A-5C are tables showing examples of the use restriction setting and the referral setting. In the multifunction device 101, the use restriction and the referral settings may be made for the multifunction device 101 as shown in FIG. 5A. In an alternative embodiment, the use restriction setting and the referral setting may be made on a per-function basis of the multifunction device 101 as shown in FIG. 5B. In a further alternative embodiment, the use restriction setting and the referral setting may be made on a per-user basis of the multifunction device 101 as shown in FIG. 5C. In a further alternative embodiment, the use restriction setting and the referral setting may be made on the per-function basis and on the per-user basis of the multifunction device 101 (i.e., for each combinations of the items in FIG. 5B and the items FIG. 5C). If the settings are made on the per-function basis, “use restriction setting: permitted, referral setting: enabled” may be applied to one function while “use restriction setting: not permitted, referral setting: disabled” may be applied to another function. If the settings are made on a per-user basis, “use restriction setting: permitted, referral setting: enabled” may be applied to one user while “use restriction setting: not permitted, referral setting: disabled” may be applied to another user.

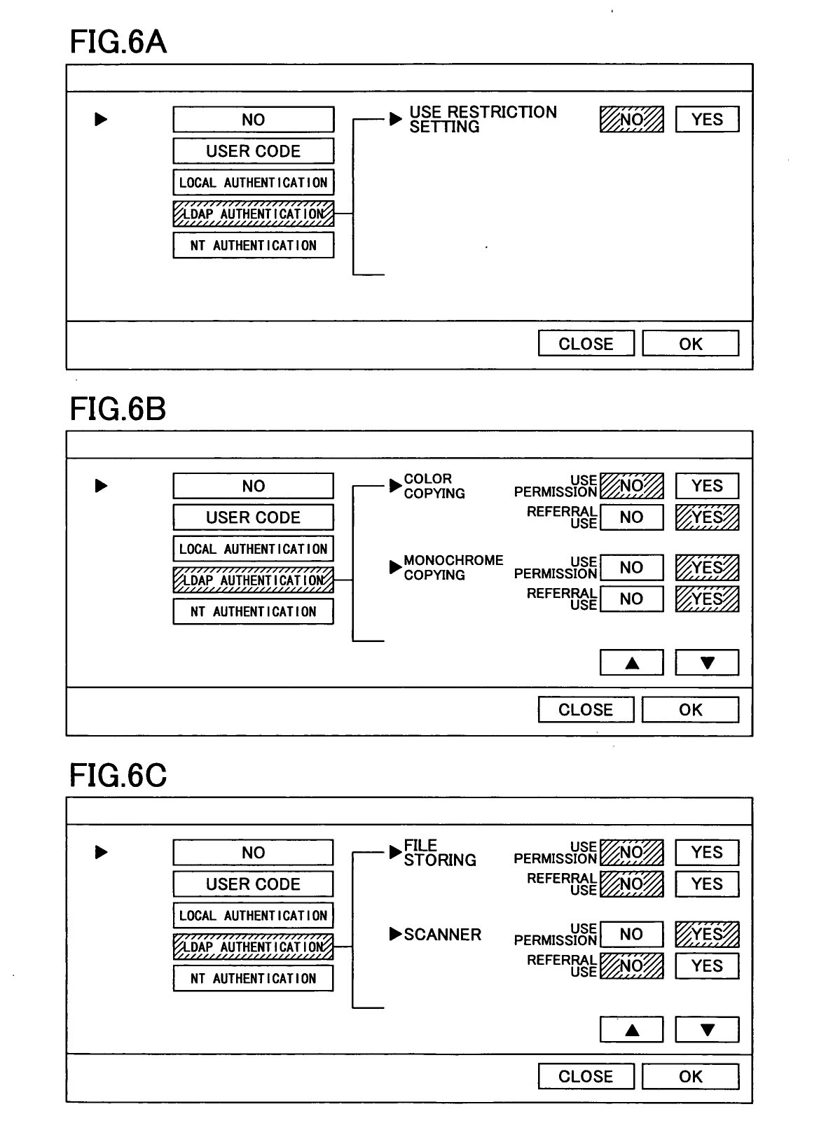

FIGS. 6A-6C are screens used for use restriction setting and referral setting. FIG. 6A shows a selection screen used for selecting whether to set use restrictions. When “YES” is selected in the screen of FIG. 6A, the screen switches to the screens of FIGS. 6B and 6C. The screens of FIGS. 6B and 6C are setting screens used for the use restriction setting and the referral setting on the per-function basis. When the use restriction setting and the referral setting are made on the per-function basis and “OK” is pressed, the authentication management module 136 applies the use restriction setting and the referral setting on the per-function basis to the multifunction device 101.

The following describes operations of authenticating users of the multifunction device 101 and operations of restricting the use of the functions of the multifunction device 101. The multifunction device 101 sends the LDAP servers 301 and the NT servers 302, which manage information about the users of the multifunction device 101, requests for, for example, authentication operations for performing operations of restricting the use of the functions of the multifunction device 101. The following describes the case where a member of the C&F development group of the R&D division attempts to use the multifunction device 101 owned by the PF development group of the R&D division.

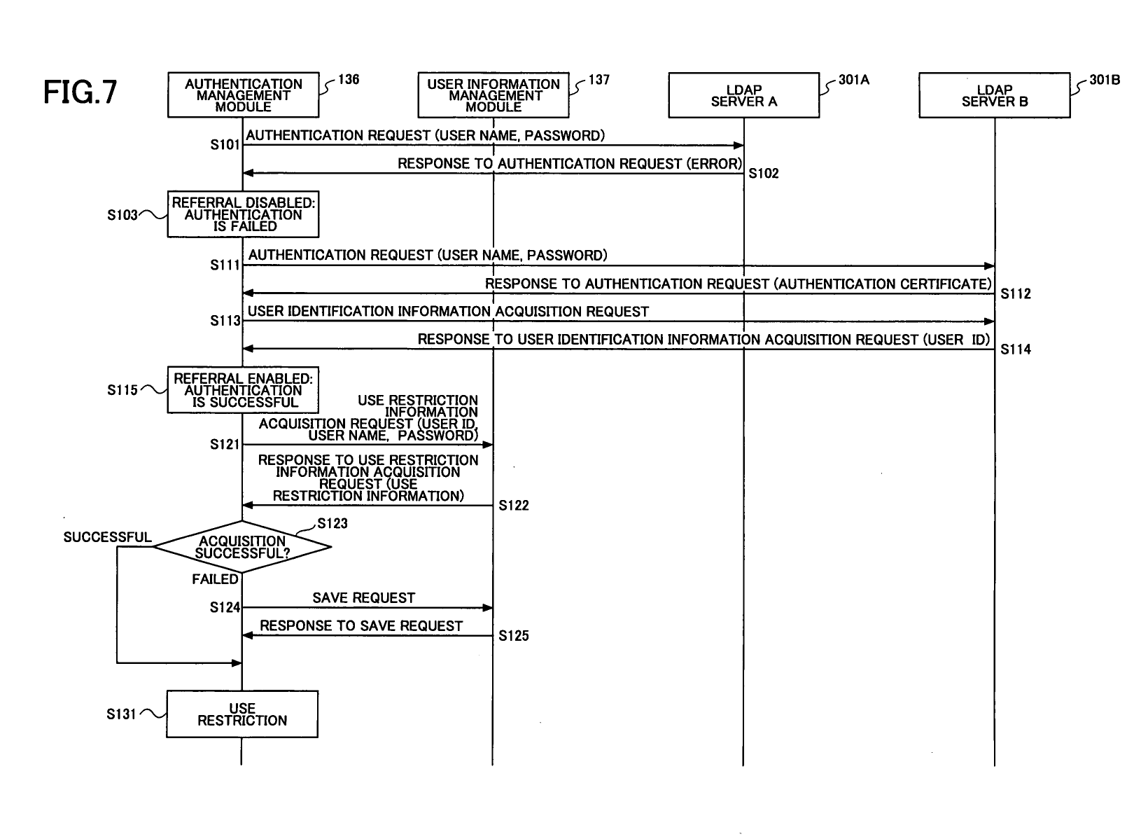

FIG. 7 is a sequence diagram illustrating a first example of the process flow of authentication (LDAP authentication).

First, the authentication management module 136 sends a user authentication request to the LDAP server 301A together with authentication information (user name and password) of the user of the multifunction device 101 input to the multifunction device 101 (SlOl). In response to the user authentication request, the LDAP server 301A returns an error message to the authentication management module 136 (S102). In this step, the LDAP server 301A refers the multifunction device 101 to the LDAP server 301B as the destination of the authentication request. Then, the authentication management module 136 saves the authentication result at the time referrals are disabled as “authentication failed” (S103).

Then, the authentication management module 136 sends the user authentication request to the LDAP server 301B together with the authentication information (user name and password) of the user of the multifunction device 101 input to the multifunction device 101 (S111). In response to the user authentication request, the LDAP server 301B sends an authentication certificate to the authentication management module 136 (S112). Then, the authentication management module 136 sends an acquisition request for user identification information of the user to the LDAP server 301B (S113). In response to the acquisition request for user identification information of the user, the LDAP server 301B sends the user identification information (user ID) of the user to the authentication management module 136 (S114). Then, the authentication management module 136 saves the authentication result at the time referral are enabled as “authentication successful” (S115).

Subsequently, the authentication management module 136 sends the user information management module 137 an acquisition request for use restriction information indicating the use restrictions of the functions of the multifunction device 101 together with the user identification information and the authentication information (user ID, user name, and password) of the user (S121). In response to the acquisition request for use restriction information indicating the use restrictions of the functions of the multifunction device 101, the user information management module 137 sends the authentication management module 136 the use restriction information (the use restriction settings shown in FIGS. 5B, 6B, and 6C), which is stored in the multifunction device 101, indicating the use restrictions of the functions of the multifunction device 101 (S122). In this step, the referral settings shown in FIGS. 5B, 6B, and 6C are sent together with the use restriction settings shown in FIGS. 5B, 6B, and 6C. If the use restriction settings or the referral settings cannot be acquired, the user identification information and the authentication information of the user may be saved in the multifunction device 101 (S123, S124, and S125). Saving the user identification information and the authentication information of the user allows the multifunction device 101 to create the entry for the user in advance in case use restriction settings and referral settings are made on a per-user basis.

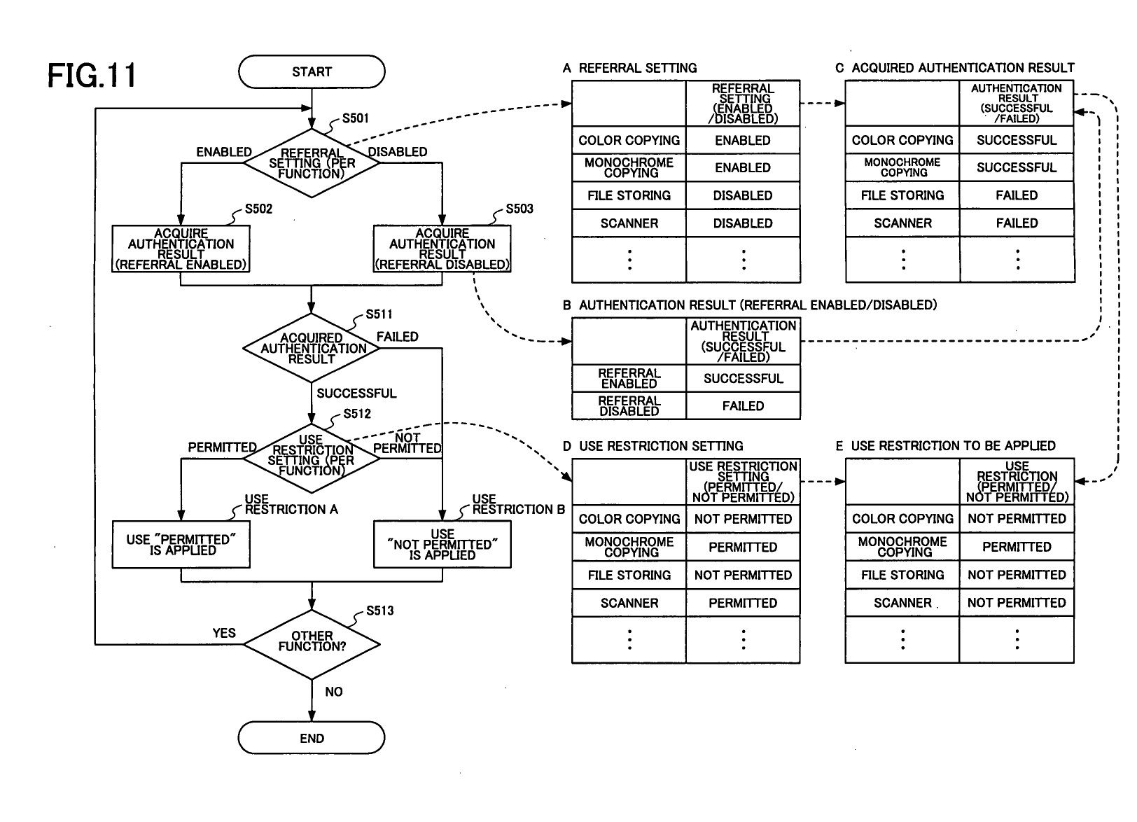

Then, the authentication management module 136 performs operations of restricting the use of the functions of the multifunction device 101 based on the authentication result, the use restriction settings, and the referral settings (S131). The operations performed in step S131 are described below in greater detail with reference to FIG. 11. In an alternative embodiment, steps S113 and S114 may be omitted. If steps S113 and S114 are omitted, the user identification information may be unnecessary in step S121, and accordingly steps S123, S124, and S125 may be omitted.

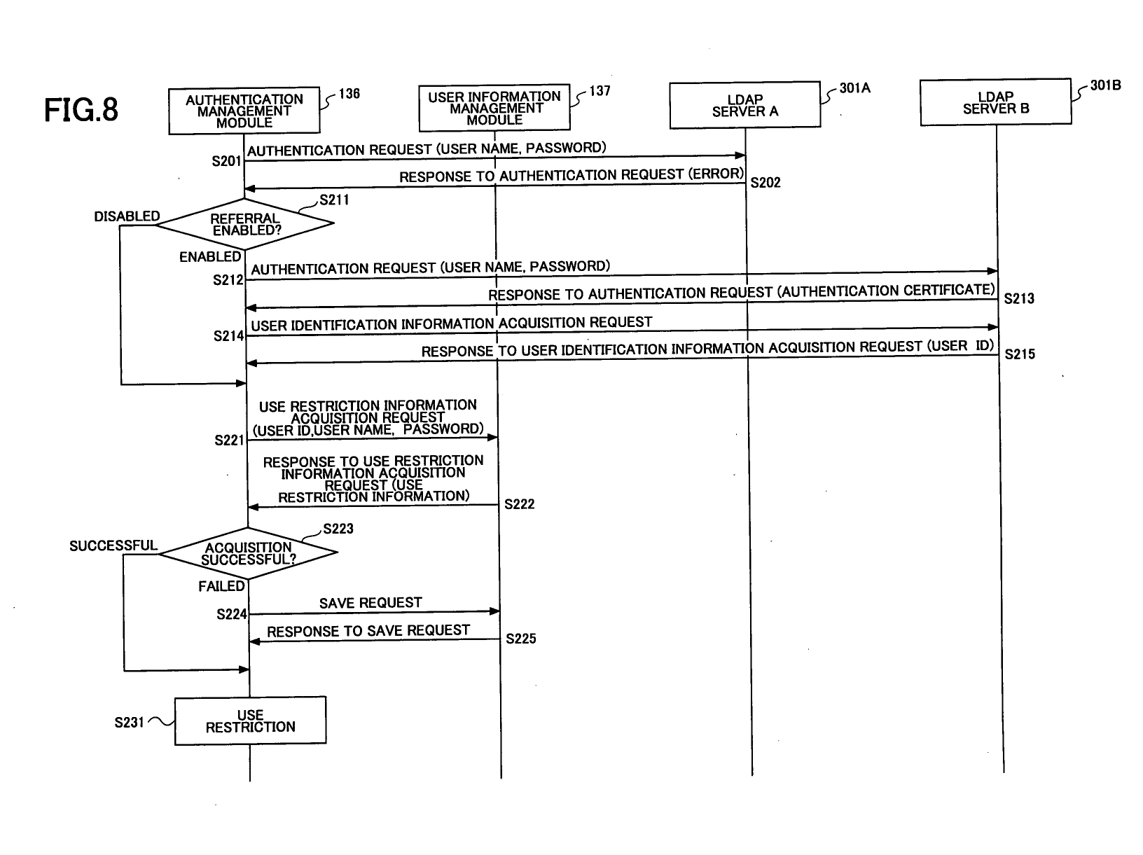

FIG. 8 is a sequence diagram illustrating a second example of the process flow of authentication (LDAP authentication).

First, the authentication management module 136 sends a user authentication request to the LDAP server 301A together with authentication information (user name and password) of the user of the multifunction device 101 input to the multifunction device 101 (S201). In response to the user authentication request, the LDAP server 301A returns an error to the authentication management module 136 (S202). In this step, the LDAP server 301A refers the multifunction device 101 to the LDAP server 301B as the destination of the authentication request.

Then, the authentication management module 136 determines whether to send the authentication request to the LDAP server 301B based on whether the referral setting is “enabled” or “disabled” (S211). If the referral setting is “enabled”, the authentication management module 136 sends the user authentication request to the LDAP server 301B together with the authentication information of the user of the multifunction device 101 input to the multifunction device 101 (S212). In response to the user authentication request, the LDAP server 301B sends an authentication certificate to the authentication management module 136 (S213). Then, the authentication management module 136 sends an acquisition request for user identification information of the user to the LDAP server 301B (S214). In response to the acquisition request for user identification information of the user, the LDAP server 301B sends the user identification information (user ID) of the user to the authentication management module 136 (S215). If the referral setting is “disabled”, operations of steps S212, S213, S214, and S215 are not performed, thereby making the processing in the second example faster than the processing in the first example.

Subsequently, the authentication management module 136 sends the user information management module 137 an acquisition request for use restriction information indicating the use restrictions of the functions of the multifunction device 101 together with the user identification information and the authentication information (user ID, user name, and password) of the user (S221). In response to the acquisition request for use restriction information indicating the use restrictions of the functions of the multifunction device 101, the user information management module 137 sends the authentication management module 136 the use restriction information (the use restriction settings shown in FIGS. 5B, 6B, and 6C), which is stored in the multifunction device 101, indicating the use restrictions of the functions of the multifunction device 101 (S222). In this step, the referral settings shown in FIGS. 5B, 6B, and 6C are sent together with the use restriction settings shown in FIGS. 5B, 6B, and 6C. If the use restriction settings or the referral settings cannot be acquired, the user identification information and the authentication information of the user may be saved in the multifunction device 101 (S223, S224, and S225). Saving the user identification information and the authentication information of the user allows the multifunction device 101 to create the entry for the user in advance in case use restriction settings and referral settings are made on a per-user basis.

Then, the authentication management module 136 performs operations of restricting the use of the functions of the multifunction device 101 based on the authentication result, the use restriction settings, and the referral settings (S231). The operations performed in step S231 are described below in greater detail with reference to FIG. 11. In an alternative embodiment, steps S214 and S215 may be omitted. If steps S214 and S215 are omitted, the user identification information may be unnecessary in step S221, and accordingly steps S223, S224, and S225 may be omitted.

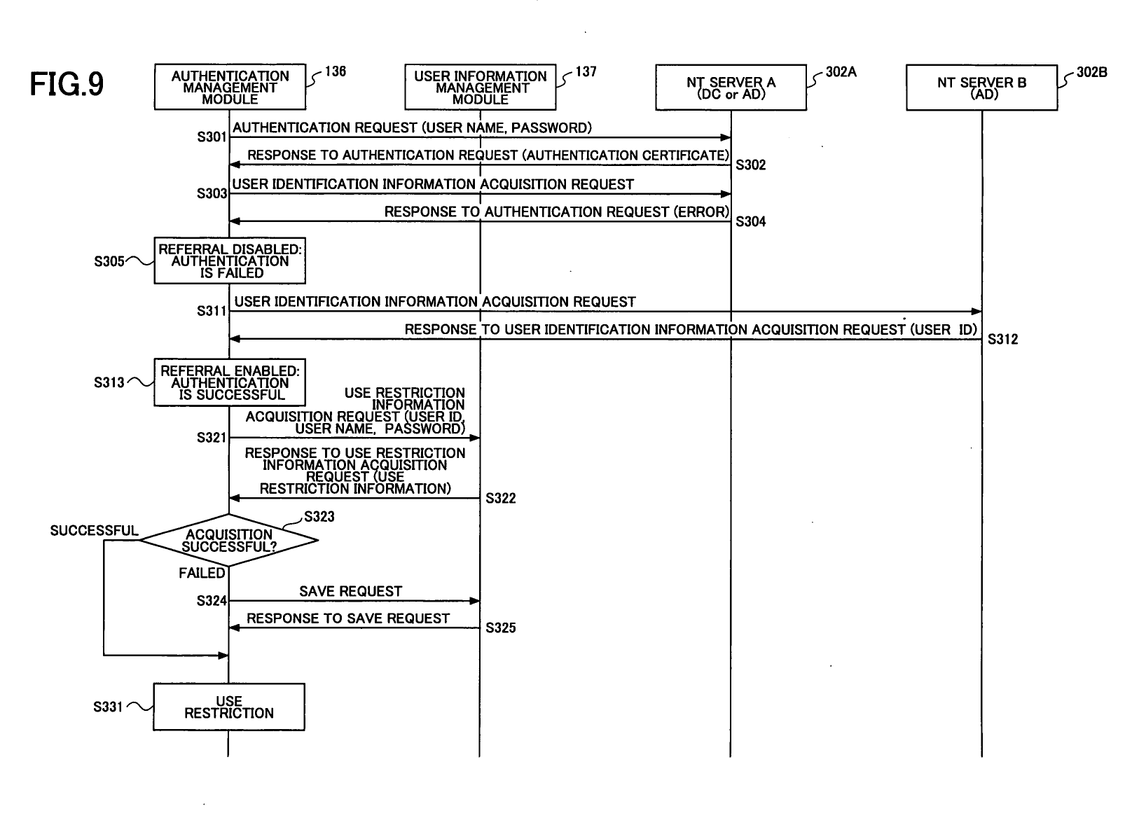

FIG. 9 is a sequence diagram illustrating a third example of the process flow of authentication (NT authentication).

First, the authentication management module 136 sends a user authentication request to the NT server 302A (DC or AD) together with authentication information (user name and password) of the user of the multifunction device 101 input to the multifunction device 101 (S301). In response to the user authentication request, the NT server 302A sends an authentication certificate to the authentication management module 136 (S302). Then, the authentication management module 136 sends an acquisition request for user identification information of the user to the NT server 302A (S303). In response to the acquisition request for user identification information of the user, the NT server 302A returns an error to the authentication management module 136 (S304). In this step, the NT server 302A refers the multifunction device 101 to the NT server 302B as the destination of the acquisition request for user identification information. Then, the authentication management module 136 saves the authentication result at the time referrals are disabled as “authentication failed” (S305).

Then, the authentication management module 136 sends the acquisition request for user identification information of the user to the NT server (AD) 302B (S311). In response to the acquisition request for user identification information of the user, the NT server 302B sends the user identification information (user ID) of the user to the authentication management module 136 (S312). Then, the authentication management module 136 saves the authentication result at the time referrals are enabled as “authentication successful” (S313).

Subsequently, the authentication management module 136 sends the user information management module 137 an acquisition request for use restriction information indicating the use restrictions of the functions of the multifunction device 101 together with the user identification information and the authentication information (user ID, user name, and password) of the user (S321). In response to the acquisition request for use restriction information indicating the use restrictions of the functions of the multifunction device 101, the user information management module 137 sends the authentication management module 136 the use restriction information (the use restriction settings shown in FIGS. 5B, 6B, and 6C), which is stored in the multifunction device 101, indicating the use restrictions of the functions of the multifunction device 101 (S322). In this step, the referral settings shown in FIGS. 5B, 6B, and 6C are sent together with the use restriction settings shown in FIGS. 5B, 6B, and 6C. If the use restrictions setting or the referral settings cannot be acquired, the user identification information and the authentication information of the user may be saved in the multifunction device 101 (S323, S324, and S325). Saving the user identification information and the authentication information of the user allows the multifunction device 101 to create the entry for the user in advance in case use restriction settings and referral settings are made on a per-user basis.

Then, the authentication management module 136 performs operations of restricting the use of the functions of the multifunction device 101 based on the authentication result, the use restriction settings, and the referral settings (S331). The operations performed in step S331 are described below in greater detail with reference to FIG. 11. In an alternative embodiment, the user identification information may be unnecessary in step S321, and accordingly steps S323, S324, and S325 may be omitted.

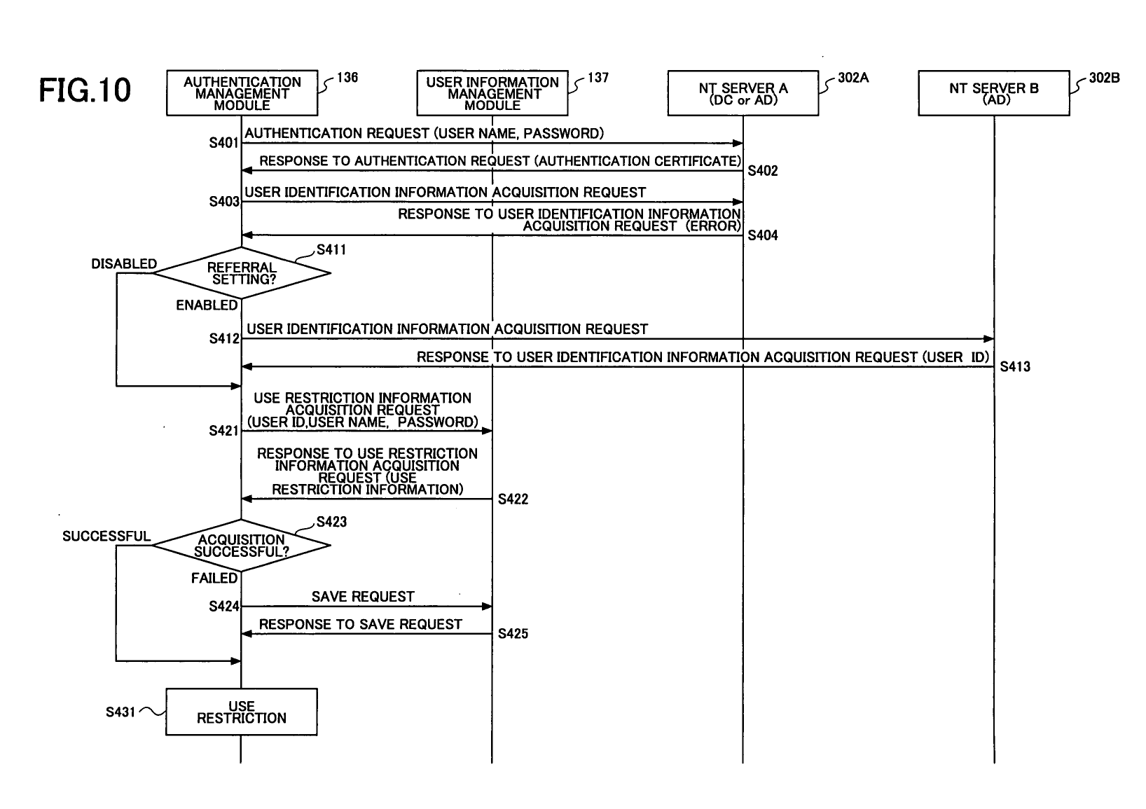

FIG. 10 is a sequence diagram illustrating a fourth example the process flow of authentication (NT authentication).

First, the authentication management module 136 sends a user authentication request to the NT server 302A (DC or AD) together with authentication information (user name and password) of the user of the multifunction device 101 input to the multifunction device 101 (S401). In response to the user authentication request, the NT server 302A sends an authentication certificate to the authentication management module 136 (S402). Then, the authentication management module 136 sends an acquisition request for user identification information of the user to the NT server 302A (S403). In response to the acquisition request for user identification information of the user, the NT server 302A returns an error to the authentication management module 136 (S404). In this step, the NT server 302A refers the multifunction device 101 to the NT server 302B as the destination of the acquisition request for user identification information.

Then, the authentication management module 136 determines whether to send the acquisition request for user identification information to the NT server (AD) 302B based on whether the referral setting is “enabled” or “disabled” (S411). If the referral setting is “enabled”, the authentication management module 136 sends the acquisition request for user identification information of the user to the NT server 302B (S412). In response to the acquisition request for user identification information of the user, the NT server 302B sends the user identification information (user ID) of the user to the authentication management module 136 (S413). If the referral setting is “disabled”, operations of steps S412 and S413 are not performed, thereby making the processing in the fourth example faster than the processing in the third example.

Subsequently, the authentication management module 136 sends the user information management module 137 an acquisition request for use restriction information indicating the use restrictions of the functions of the multifunction device 101 together with the user identification information and the authentication information (user ID, user name, and password) of the user (S421). In response to the acquisition request for use restriction information indicating the use restrictions of the functions of the multifunction device 101, the user information management module 137 sends the authentication management module 136 the use restriction information (the use restriction settings shown in FIGS. 5B, 6B, and 6C), which is stored in the multifunction device 101, indicating the use restrictions of the functions of the multifunction device 101 (S422). In this step, the referral settings shown in FIGS. 5B, 6B, and 6C are sent together with the use restriction settings shown in FIGS. 5B, 6B, and 6C. If the use restriction settings or the referral settings cannot be acquired, the user identification information and the authentication information of the user may be saved in the multifunction device 101 (S423, S424, and S425). Saving the user identification information and the authentication information of the user allows the multifunction device 101 to create the entry for the user in advance in case use restriction settings and referral settings are made on a per-user basis.

Then, the authentication management module 136 performs operations of restricting the use of the functions of the multifunction device 101 based on the authentication result, the use restriction settings, and the referral settings (S431). The operations performed in step S431 are described below in greater detail with reference to FIG. 11. In an alternative embodiment, the user identification information may be unnecessary in step S421, and accordingly steps S423, S424, and S425 may be omitted.

FIG. 11 is a flowchart illustrating a use restriction operation. The use restriction operation of FIG. 11 corresponds to the use restriction operations in step S131, S231, S331, and S431 of FIGS. 7, 8, 9, and 10.

The authentication management module 136 refers to the referral setting of one function of the multifunction device 101 (S501). If the referral setting of the function is “enabled”, the authentication result at the time referrals are enabled is acquired (S502). On the other hand, if the referral setting of the function is “disabled”, the authentication result at the time referrals are disabled is acquired (S503). In the examples of FIG. 7 and FIG. 9, the authentication results saved step S115 and step S313 correspond to the authentication results acquired in step S502, and the authentication results acquired in step S103 and step S305 correspond to the authentication results acquired in step S503. In the examples of FIG. 8 and FIG. 10, the acquisition of the authentication results of step S502 and S503 are already substantially performed as in steps S211 and S411.

The referral setting in this example is as shown in Table A of FIG. 11. This setting is the same as the setting shown in FIG. 5B. The authentication results at the time referrals are enabled and disabled are as shown in Table B of FIG. 11. The authentication results shown in Table B are the same as the authentication results in the examples of FIGS. 7, 8, 9, and 10. Accordingly, the authentication results acquired in steps S502 and S503 are as shown in Table C of FIG. 11.

The authentication management module 136 then refers to the authentication results acquired in steps S502 and S503 (S511). If the authentication result of the function is “failed”, the use “not permitted” is applied (use restriction B). On the other hand, if the authentication result is “successful”, the use restriction setting of the function is referred to (S512). If the use restriction setting of the function is “not permitted”, the use “not permitted” is applied (use restriction B). On the other hand, if the use restriction setting of the function is “permitted”, the use “permitted” is applied (use restriction A). Theses operations are performed for each of the functions of the multifunction device 101 (S513).

The use restriction setting in this example is as shown in Table D of FIG. 11. This setting is the same as the use restriction setting shown in FIG. 5B. Accordingly, the use restrictions to be applied to the functions of the multifunction device 101 are as shown in Table E of FIG. 11.

In the authentication operations shown in FIGS. 7, 8, 9, and 10 and the use restriction operation shown in FIG. 11, the use restriction operations for the functions of which referral settings are “enabled” are performed according to the authentication result from the LDAP server 301A (NT server 302A) and the authentication result from the LDAP server 301B (NT server 302B). On the other hand, the use restriction operations for the functions of which referral settings are “disabled” are performed according to authentication result from the LDAP server 301A (NT server 302A), but regardless of the authentication result from the LDAP server 301B (NT server 302B). In this embodiment, the authentication result from the LDAP server 301A (NT server 302A), which manages the information about the members of the PF development group, is “successful” only when the user is a member of the PF development group. That is, by setting the use restriction setting and the referral setting of one function to “permitted” and “disabled”, respectively, the use permission of that function is given only to the members of the PF development group. As described above, the multifunction device 101 is configured such that users can be divided into groups by only setting “enabled” or “disabled” in the referral setting. Further, the use restrictions can be imposed on a per-user group basis by only setting “permitted” or “not permitted” in the use restriction setting. The multifunction device 101 is advantageous because LDAP servers and NT serves generally manage user information on a user group basis (on a per-company basis, on a per-division basis, on a per-location basis, etc.).

As described above, if the referral setting is enabled, the multifunction device 101 performs operations of restricting the use of the functions of the multifunction device 101 according to the response to the authentication request sent from the LDAP server 301B (NT server 302B) to which the LDAP server 301A (NT server 302A) referred the multifunction device 101. On the other hand, if the referral setting is disabled, the multifunction device 101 performs operations of restricting the use of the functions of the multifunction device 101 regardless of the response to the authentication request sent from LDAP server 301B (NT server 302B) to which the LDAP server 301A (NT server 302A) referred the multifunction device 101.

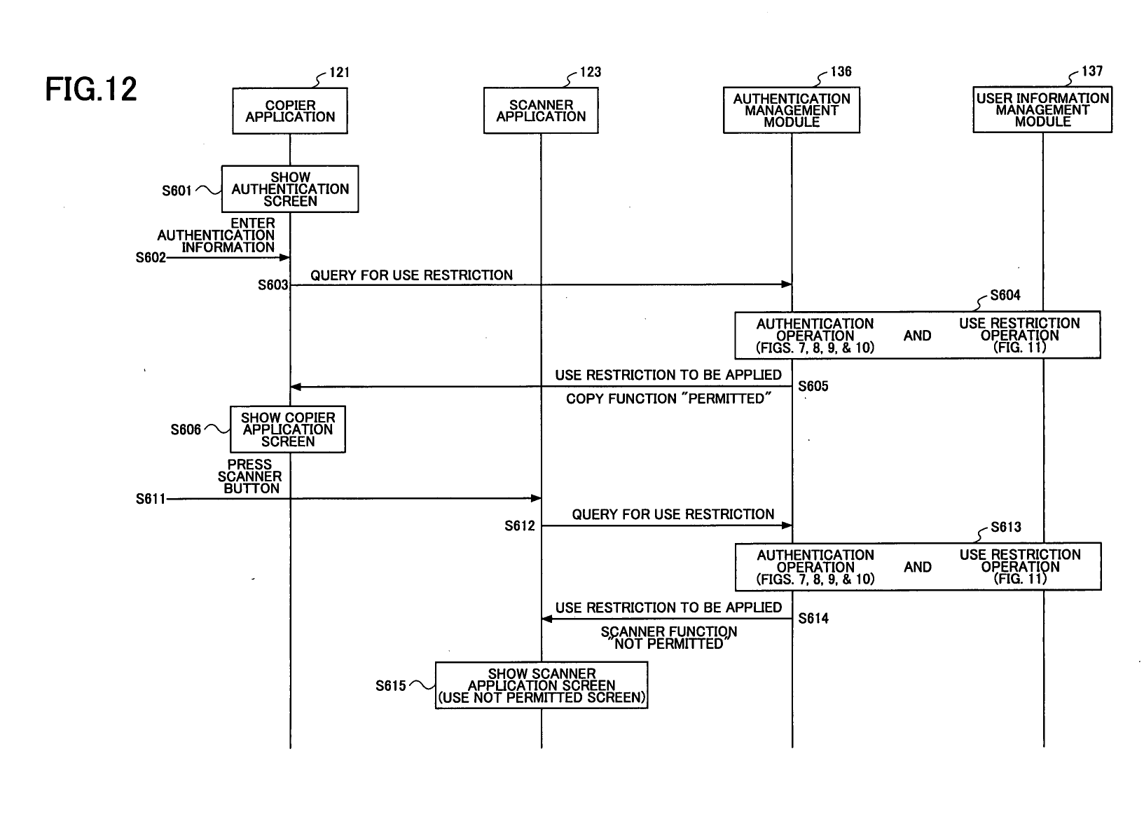

FIG. 12 is a sequence diagram illustrating steps taken when an authentication operation and a use restriction operation are performed separately by individual applications. The following describes the case where the copier application 121 having the copy function and the scanner application 123 having the scanner function are present.

When the multifunction device 101 is started, the copier application 121 shows an authentication screen (S601). Then, the authentication information of a user who attempts to use the multifunction device 101 is input (S602), so that the copier application 121 sends the authentication management module 136 a query for the use restrictions of the functions of the multifunction device 101 (S603). Then, the authentication management module 136 performs one of the authentication operations of FIGS. 7, 8, 9 and 10, and the use restriction operation of FIG. 11 for the copy function of the copier application 121 (S604). The authentication management module 136 sends the copier application 121 a use restriction of the corresponding function of the multifunction device 101 to be applied, indicating “copy function: permitted” (S605). Upon reception of the use restriction of the corresponding function of the multifunction device 101 to be applied, indicating “copy function: permitted”, the copier application 121 shows a copier application screen (S606).

When a scanner button on the operations panel 222 is pressed (S611) in order to switch from the copier application screen (copy function) to a scanner application screen (scanner function), the scanner application 123 sends the authentication management module 136 a query for the use restrictions of the functions of the multifunction device 101 (S612). Then, the authentication management module 136 performs one of the authentication operations of FIGS. 7, 8, 9 and 10, and the use restriction operation of FIG. 11 for the scanner function of the scanner application 123 (S613). The authentication management module 136 sends the scanner application 123 a use restriction of the corresponding function of the multifunction device 101 to be applied, indicating “scanner function: not permitted” (S614). Upon reception of the use restriction of the corresponding function of the multifunction device 101 to be applied, indicating “scanner function: not permitted”, the scanner application 123 shows a scanner application screen (use-not-permitted screen) (S615)

It is to be noted that the queries in step S603 and S612 are sent together with the authentication information input in the authentication screen. The authentication screen may be therefore shown again when switching the screens (functions).

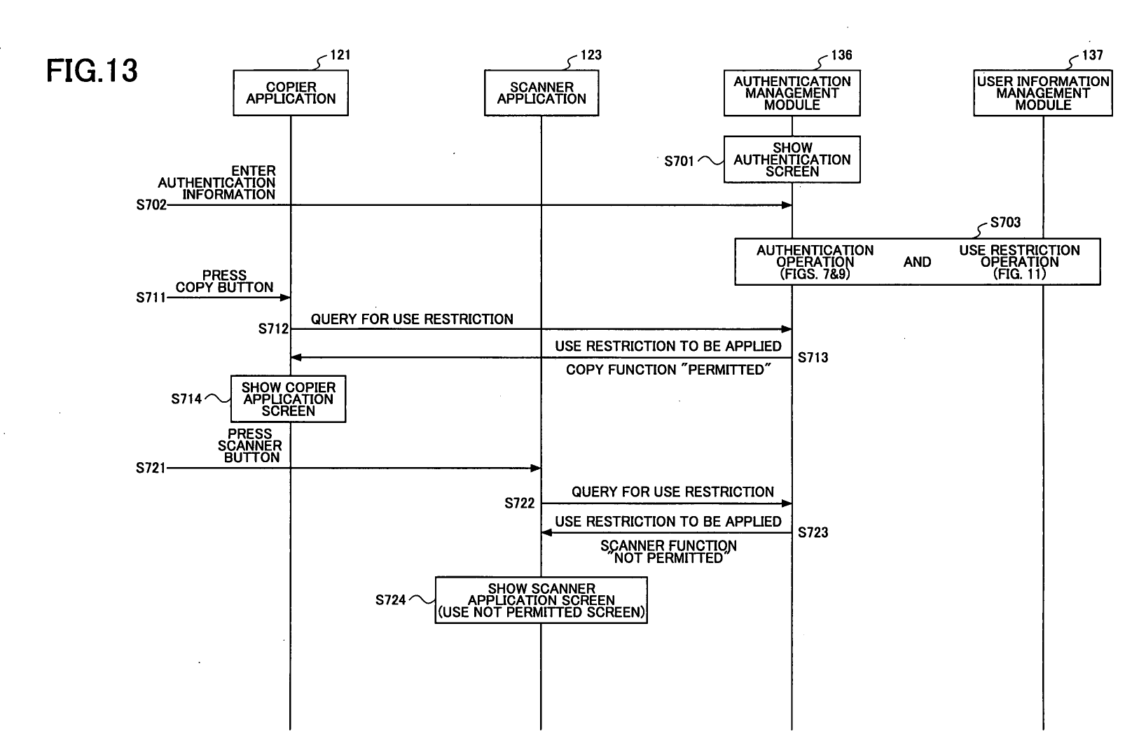

FIG. 13 is a sequence diagram illustrating steps taken when an authentication operation and a use restriction operation are performed jointly by all the applications. The following describes the case where the copier application 121 having the copy function and the scanner application 123 having the scanner function are present.

When the multifunction device 101 is started, the authentication management module 136 shows the authentication screen (S701). Then, the authentication information of a user who attempts to use the multifunction device 101 is input (S702), so that the authentication management module 136 performs one of the authentication operations of FIGS. 7 and 9, and the use restriction operation of FIG. 11 for the copy function of the copier application 121 (S703).

When a copy button on the operations panel 222 is pressed (S711) in order to switch to the copier application screen (copy function) the copier application 121 sends the authentication management module 136 a query for the use restrictions of the functions of the multifunction device 101 (S712). The authentication management module 136 sends the copier application 121 a use restriction of the corresponding function of the multifunction device 101 to be applied, indicating “copy function: permitted” (S713). Upon reception of the use restriction of the corresponding function of the multifunction device 101 to be applied, indicating “copy function: permitted”, the copier application 121 shows a copier application screen (S714).

If the scanner button on the operations panel 222 is pressed (S721) in order to switch to the scanner application screen (scanner function), the scanner application 123 sends the authentication management module 136 a query for the use restrictions of the functions of the multifunction device 101 (S722). The authentication management module 136 sends the scanner application 123 a use restriction of the corresponding function of the multifunction device 101 to be applied, indicating “scanner function: not permitted” (S723). Upon reception of the use restriction of the corresponding function of the multifunction device 101 to be applied, indicating “scanner function: not permitted”, the scanner application 123 shows the scanner application screen (use-not-permitted screen) (S724).

In place of sending queries for the use restriction of the corresponding functions of the multifunction device 101 from the copier application 121 and the scanner application 123 to the authentication management module 136 and returning the use restriction to be applied from authentication management module 136, the authentication management module 136 may deliver tickets to the copier application 121 and the scanner application 123.

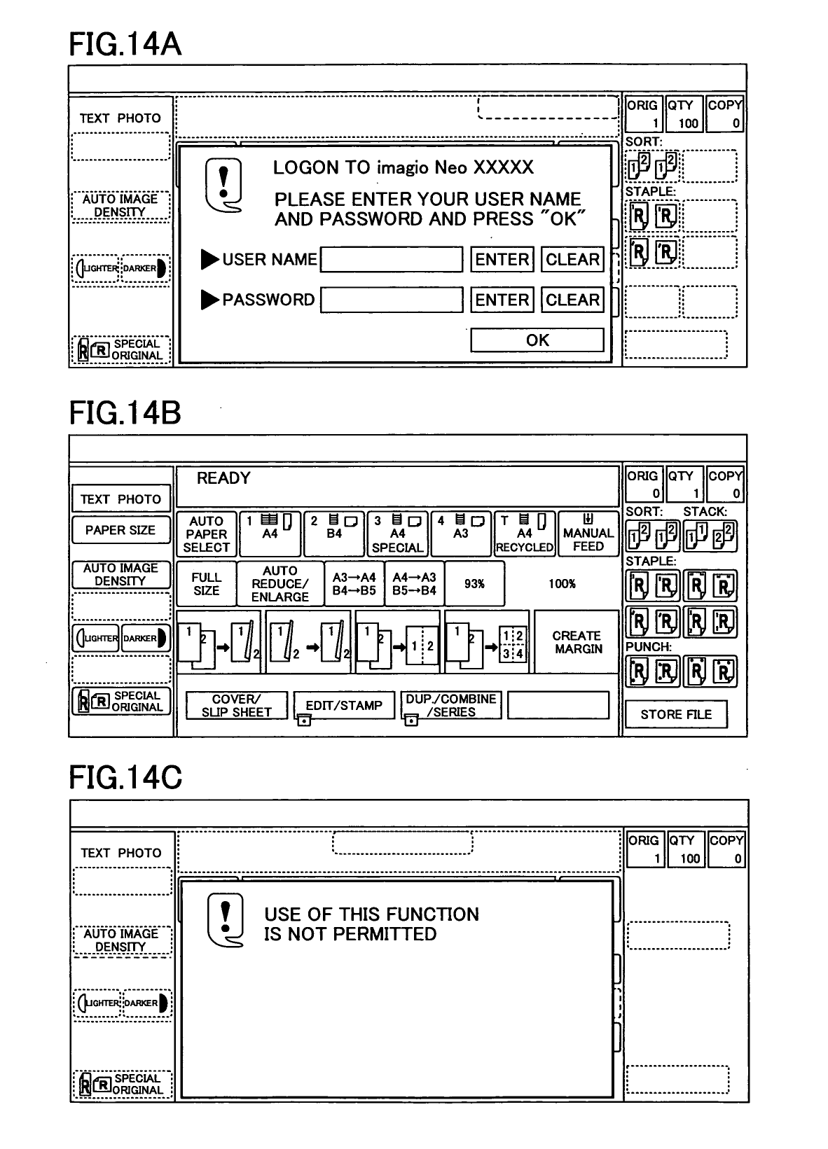

FIGS. 14A-14C show examples of the authentication screen, the copier application screen, and the scanner application screen (use-not-permitted screen) of FIGS. 12 and 13;

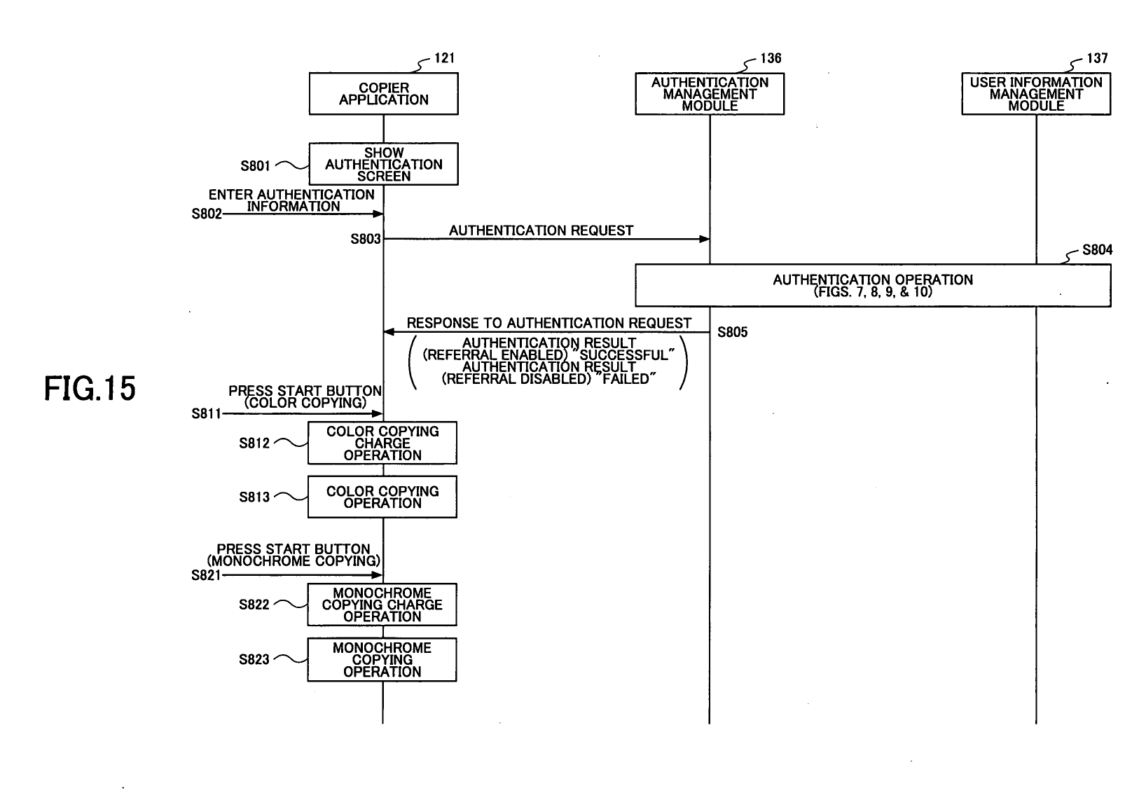

FIG. 15 is a sequence diagram illustrating a modified example of FIGS. 12 and 13.

When the multifunction device 101 is started, the copier application 121 shows an authentication screen (S801). Then, the authentication information of a user who attempts to use the multifunction device 101 is input (S802), so that the copier application 121 sends a user authentication request to the authentication management module 136 (S803). Then, the authentication management module 136 performs one of the authentication operations of FIGS. 7, 8, 9 and 10 for the copy function of the copier application 121 (S804). In response to the user authentication request, the authentication management module 136 sends the copier application 121 the authentication result at the time referrals are enabled, which is “authentication successful” and the authentication result at the time referrals are disabled, which is “authentication failed” (S805).

When a start button on the operations panel 222 is pressed (S811) in a color copying mode, the copier application 121 performs a color copying charging operation (S812) and then performs a color copying operation (S813). When a start button on the operations panel 222 is pressed (S821) in a monochrome copying mode, the copier application 121 performs a monochrome copying charging operation (S822) and then performs a monochrome copying operation (S823).

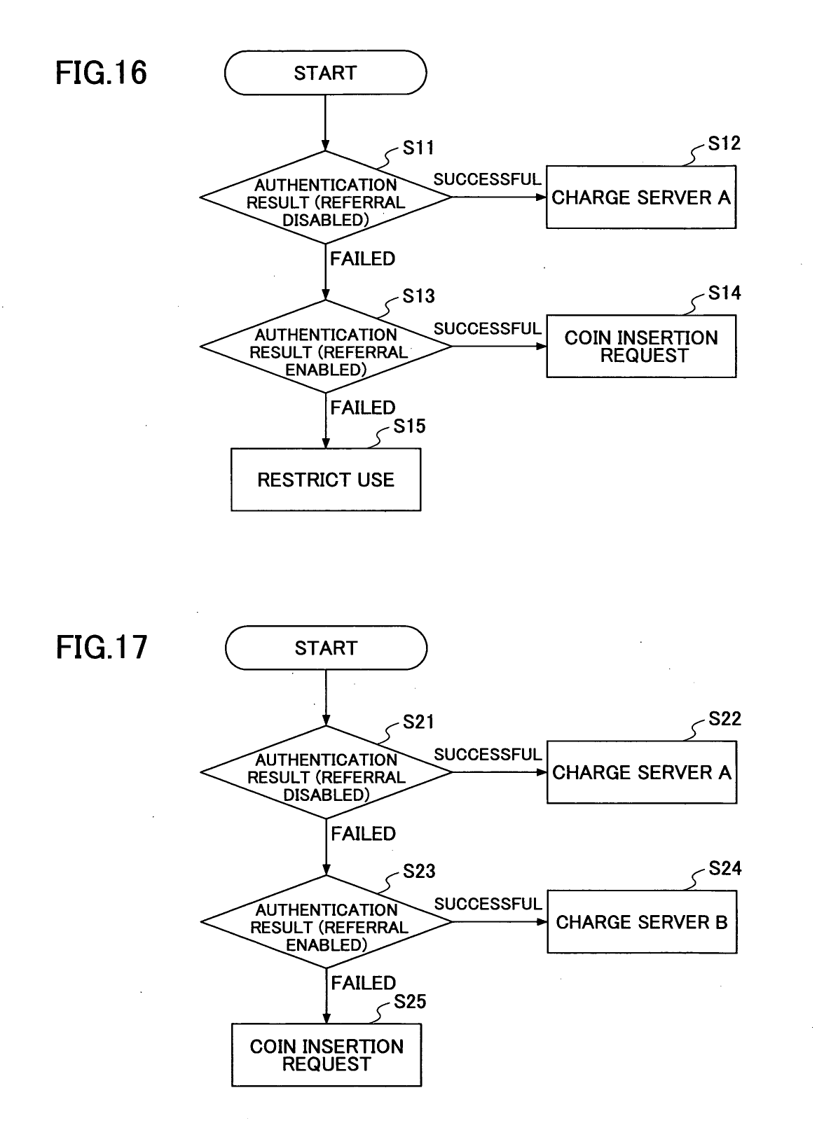

FIG. 16 is a flowchart showing the color copying charging operation of step S812.

The authentication management module 136 refers to the authentication result at the time referrals are disabled (S11). If the authentication result at the time referrals are disabled is “successful”, the authentication management module 136 charges a server corresponding to the LDAP server 301A or the NT server 302A (S12). If the authentication result at the time referrals are disabled is “failed”, the authentication management module 136 refers to the authentication result at the time referrals are enabled (S13). If the authentication result at the time referrals are enabled is “successful”, a request screen that requests insertion of coin (fee) is displayed (S14). If the authentication result at the time referrals are enabled is “failed”, a restriction screen that indicates that the use is not permitted is displayed (S15).

FIG. 17 is a flowchart showing a monochrome copying charging operation of step S822.

The authentication management module 136 refers to the authentication result at the time referrals are disabled (S21). If the authentication result at the time referrals are disabled is “successful”, the authentication management module 136 charges a server corresponding to the LDAP server 301A or the NT server 302A (S22). If the authentication result at the time referrals are disabled is “failed”, the authentication management module 136 refers to the authentication result at the time referrals are enabled (S23). If the authentication result at the time referrals are enabled is “successful”, the authentication management module 136 charges a server corresponding to the LDAP server 301B or the NT server 302B (S24). If the authentication result at the time referrals are enabled is “failed”, the request screen that requests insertion of coin (fee) is displayed (S25).

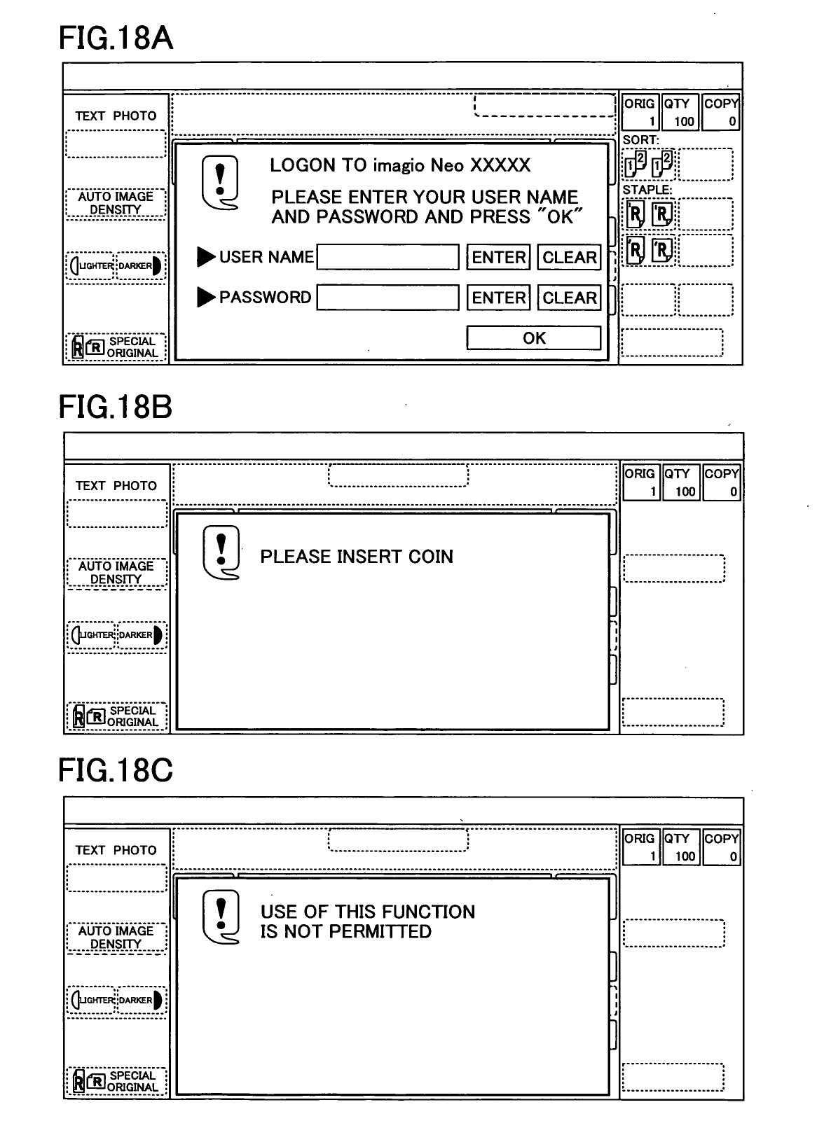

FIGS. 18A-18C show examples of the authentication screen, the request screen, and the restriction screen of FIGS. 15, 16, and 17.

The present application is based on Japanese Priority Application No. 2005-002652 filed on Jan. 7, 2005, with the Japanese Patent Office, the entire contents of which are hereby incorporated by reference.

What is claimed is:

1. A communication apparatus operating as a client of a first server having a referral function for referring the communication apparatus to a second server that performs an operation requested by the communication apparatus, comprising:
a requesting unit that sends, to the first server or the second server that manages information about a user of the communication apparatus, a request for the operation for applying a use restriction of one or more functions of the communication apparatus;
a setting unit that determines whether to enable or disable a referral using the referral function; and
a use restricting unit that applies the use restriction of one or more functions of the communication apparatus according to a response to the request sent from the requesting unit and the determination by the setting unit.

2. The communication apparatus as claimed in claim 1, wherein the requesting unit sends the request for the operation together with authentication information of the user input to the communication apparatus.

3. The communication apparatus as claimed in claim 1, wherein the use restricting unit applies the use restriction of one or more functions of the communication apparatus based on use restriction information, indicating the use restrictions of one or more functions of the communication apparatus, stored in the communication apparatus.

4. The communication apparatus as claimed in claim 1, wherein the use restricting unit applies the use restriction of one or more functions of the communication apparatus according to the response to the request sent to the second server to which the first server has referred the communication apparatus using the referral function if the referral using the referral function is enabled, and applies the use restriction of one or more functions of the communication apparatus regardless of the response to the request sent to the second server to which the first server referred the communication apparatus using the referral function if the referral using the referral function is disabled.

5. The communication apparatus as claimed in claim 1, wherein the setting unit determines whether to enable or disable the referral using the referral function on a per-function basis of the communication apparatus.

6. The communication apparatus as claimed in claim 1, wherein the setting unit determines whether to enable or disable the referral using the referral function on a per-user basis of the communication apparatus.

7. The communication apparatus as claimed in claim 1, wherein the setting unit determines whether to enable or disable the referral using the referral function on a per-function basis and on a per-user basis of the communication apparatus.

8. The communication apparatus as claimed in claim 1, wherein the use restriction of a first function of the functions of the communication apparatus to be applied is determined when switching to the first function from a second function of the functions of the communication apparatus.

9. The communication apparatus as claimed in claim 1, wherein the information about the user of the communication apparatus contained in the response to the request sent from the requesting unit is saved in the communication apparatus.

10. The communication apparatus as claimed in claim 1, wherein determination whether to send the request for the operation to the second server is made based on whether the referral using the referral function is enabled or disabled when the first server refers the communication apparatus to the second server as the response to the request sent from the requesting unit.

11. The communication apparatus as claimed in claim 1, wherein the first and second servers are LDAP servers or NT servers.

12. A communication method performed by a communication apparatus operating as a client of a first server having a referral function for referring the communication apparatus to a second server that performs an operation requested by the communication apparatus, comprising:
a requesting step of sending, to the first server or the second server that manages information about a user of the communication apparatus, a request for the operation for applying a use restriction of one or more functions of the communication apparatus;
a setting step of determining whether to enable or disable a referral using the referral function; and
a use restricting step of applying the use restriction of one or more functions of the communication apparatus according to a response to the request sent in the requesting step and the determination in the setting step.

13. The communication method as claimed in claim 12, wherein the request for the operation is sent together with authentication information of the user input to the communication apparatus in the requesting step.

14. The communication method as claimed in claim 12, wherein the use restriction of one or more functions of the communication apparatus is applied based on use restriction information, indicating the use restrictions of one or more functions of the communication apparatus, stored in the communication apparatus in the use restricting step.

15. The communication method as claimed in claim 12, wherein the use restriction of one or more functions of the communication apparatus is applied according to the response to the request sent to the second server to which the first server has referred the communication apparatus using the referral function if the referral using the referral function is enabled, and is applied regardless of the response to the request sent to the second server to which the first server referred the communication apparatus using the referral function if the referral using the referral function is disabled in the use restricting step.

16. The communication method as claimed in claim 12, wherein whether to enable or disable the referral using the referral function is determined on a per-function basis of the communication apparatus in the setting step.

17. The communication method as claimed in claim 12, wherein whether to enable or disable the referral using the referral function is determined on a per-user basis of the communication apparatus in the setting step.

18. The communication method as claimed in claim 12, wherein whether to enable or disable the referral using the referral function is determined on a per-function basis and on a per-user basis of the communication apparatus in the setting step.

19. The communication method as claimed in claim 12, wherein the use restriction of a first function of the functions of the communication apparatus to be applied is determined when switching to the first function from a second function of the functions of the communication apparatus.

20. The communication method as claimed in claim 12, wherein the information about the user of the communication apparatus contained in the response to the request sent in the requesting step is saved in the communication apparatus.

21. The communication method as claimed in claim 12, wherein determination whether to send the request for the operation to the second server is made based on whether the referral using the referral function is enabled or disabled when the first server refers the communication apparatus to the second server as the response to the request sent in the requesting step.

22. The communication method as claimed in claim 12, wherein the first and second servers are LDAP servers or NT servers.

23. A recording medium storing a program executable by a communication apparatus operating as a client of a first server having a referral function for referring the communication apparatus to a second server that performs an operation requested by the communication apparatus, the program comprising:
a requesting instruction for sending, to the first server or the second server that manages information about a user of the communication apparatus, a request for the operation for applying a use restriction of one or more functions of the communication apparatus;
a setting instruction for determining whether to enable or disable a referral using the referral function; and
a use restricting instruction for applying the use restriction of one or more functions of the communication apparatus according to a response to the request sent according to the requesting instruction and the determination according to the setting instruction.

24. A communication method for use in a first server having a referral function for referring a communication apparatus to a second server that performs an operation requested by the communication apparatus, and in the communication apparatus operating as a client of the first server, comprising:
a requesting step of causing the communication apparatus to send, to the first server or the second server that manages information about a user of the communication apparatus, a request for the operation for applying a use restriction of one or more functions of the communication apparatus;
a setting step of causing the communication apparatus to determine whether to enable or disable a referral using the referral function; and
a use restricting step of causing the communication apparatus to apply the use restriction of one or more functions of the communication apparatus according to a response to the request sent in the requesting step and the determination in the setting step.
